(19) United States
(12) Patent Application Publication
(10) Pub. No.: US 2006/0020437 A1
(43) Pub. Date: Jan. 26, 2006

(54) Computer system and method for calculating an index to evaluate the quality of an automobile interior trim part

(75) Inventors: Marco Braun, Lug (DE); Steve Kober, Treuen (DE); Volker Doll, Ranschbach (DE); Jurgen Prokop, Landau (DE)

Correspondence Address: FLEIT KAIN GIBBONS GUTMAN BONGINI & BIANCO, 21355 EAST DIXIE HIGHWAY, SUITE 115, MIAMI, FL, 33180, US

(73) Assignee: FAURECIA INNENRAUM SYSTEME GmbH, HAGENBACH (DE)

(21) Appl. No.: 11/035,409

(22) Filed: Jan. 12, 2005

(30) Foreign Application Priority Data
Jul. 23, 2004 (DE) 10 2004 035 838.9

(51) Int. Cl. G06G 7/48

(52) U.S. Cl. 703/8

(57) ABSTRACT

An improved system for designing vehicle interior trim parts or modules includes means for storing a specified package space profile and a CAD program for designing a module to be accommodated in the package space profile. The volume of the package space and the volume of the module are calculated. The ratio of the module volume to the package space volume is calculated and displayed on a screen.

### TECHNICAL FIELD

The invention relates to a computer system, a specification of an index for evaluating the quality of an automobile interior trim part, and a method for determining an index value of said type.

### BACKGROUND OF THE INVENTION

Various computer-aided systems, so-called CAD or CAX systems, are known from the prior art, which can be used for computer-aided design and/or computer-aided simulation of modules.

For example, a computer-aided system and method for arranging control components in the interior of an automobile is known from U.S. Pat. No. 6,113,644.

A computer-aided method for designing the so-called HVAC (heating, ventilation, and air-conditioning) components of an automobile are known from U.S. Pat. No. 6,477,518. A knowledge-based method is employed in this case, in order to fulfill cost and weight specifications for the design.

### SUMMARY OF THE INVENTION

In contrast, the task that forms the basis of this invention is to create an improved computer system for the design of modules; in particular, of automobile interior trim parts, of a specification of an index for evaluating the quality of an automobile interior trim part, and of a method for determining an index value of said type.

The tasks that form the basis of this invention are each solved through the features of the independent patent claims. Preferred embodiments of the invention are given in the dependent patent claims.

The invention creates an index for objectively evaluating the quality of the design of a module. In particular, the index is an objective measure of the customer benefits provided to a user, e.g., with regard to range of functions, storage space, and/or comfort. The index according to the invention supplements the standard evaluation of modules with regard to cost and weight within the automobile manufacturing industry.

For this purpose, according to the invention, the volume enclosed by the module is set in proportion to the package space. For a fully completed module, a high index value represents high module quality, since a large proportion of the available package space is used for functional components. In this manner, an additional objective quality index is created alongside the cost and the weight of a module, which can be used for objective comparisons of fully manufactured modules.

For example, the design of a module can initially be optimized to ensure that the index value increases as little as possible when components are added, in order to keep as much of the package space free as possible for further components. Hence, in the module design phase, an index value that is as low as possible can indicate high-quality part design, whereas a high index value is sought for the completed module.

In a further aspect, the invention relates to a computer system with a means to store a specified package space profile, such as may be specified by an automobile manufacturer, for example. The computer system has a CAD or CAX program for designing a module to be accommodated within the package space profile. The computer system has a means of calculating the volume of the package space from the package space profile and a means of calculating the volume of the module.

Preferably, the specification of the package space profile and the specification of the module are effected through corresponding CAD/CAX data, from which the volume of the package space and the volume of the module, respectively, can be automatically calculated. A ratio is calculated from the volume of the module and the volume of the package space, and the corresponding index value is displayed on a screen. The user of the computer system can use the index value to draw conclusions on the quality of the module design. As long as the module design has not yet been completed, the lowest possible index value is sought, since this means that the greatest possible space is left for further components. Once the module has been completed, however, the index value should be as large as possible.

According to a preferred embodiment of the invention, the computer system has a means of comparing the ratio to a reference value, whereby, depending on the result of this comparison, a first or a second signal is emitted. For example, in the design phase, the first signal is emitted if the ratio is smaller than the reference value; while in the evaluation phase of the completed module design, the first signal is emitted if the ratio is greater than the reference value. As an example, the first signal could be a green symbol, and the second signal could be a red symbol.

According to a further embodiment of the invention, the computer system has a user interface for entering a user request to calculate the index value. For example, the user begins by entering a design or a part design of the module in the CAD program. The user then uses the mouse to click on a virtual control, in order to request that the ratio be calculated. Preferably, the ratio is subdivided by the module's component groups.

According to a further aspect, the invention relates to the specification of an index for evaluating the quality of an automobile interior trim part as the ratio of the volume of the automobile interior trim part and the volume of a specified package space in which the automobile interior trim part is to be accommodated. This index may be composed of several sub-indices, whereby each sub-index corresponds to a corresponding sub-group of components of the automobile interior trim part.

According to a preferred embodiment of the invention, the automobile interior trim part comprises a door module.

According to a preferred embodiment of the invention, the automobile interior trim part comprises a cockpit module, i.e., an instrument panel with air-conditioning components, storage components, and further functional components.

In a further aspect, the invention relates to a method for determining the index value. For this purpose, the volume of the module, i.e., of the automobile interior trim part, is automatically calculated from the CAD/CAX specification data for the module. If there is already at least a model or a prototype of the automobile interior trim part, then the volume of this can also be determined by means of photometric or optical methods or from the displacement volume of the automobile interior trim part in a fluid.

### BRIEF DESCRIPTION OF THE DRAWINGS

In the following paragraphs, preferred embodiments of the invention shall be described in more detail with reference to the drawings. These show the following:

FIG. 1 is a block diagram of an embodiment of a computer system according to the invention,

FIG. 2 is a tabular output on the screen of the computer system of FIG. 1, and,

FIG. 3 is a flow diagram of an embodiment of the method according to the invention.

### DETAILED DESCRIPTION OF THE PREFERRED EMBODIMENT

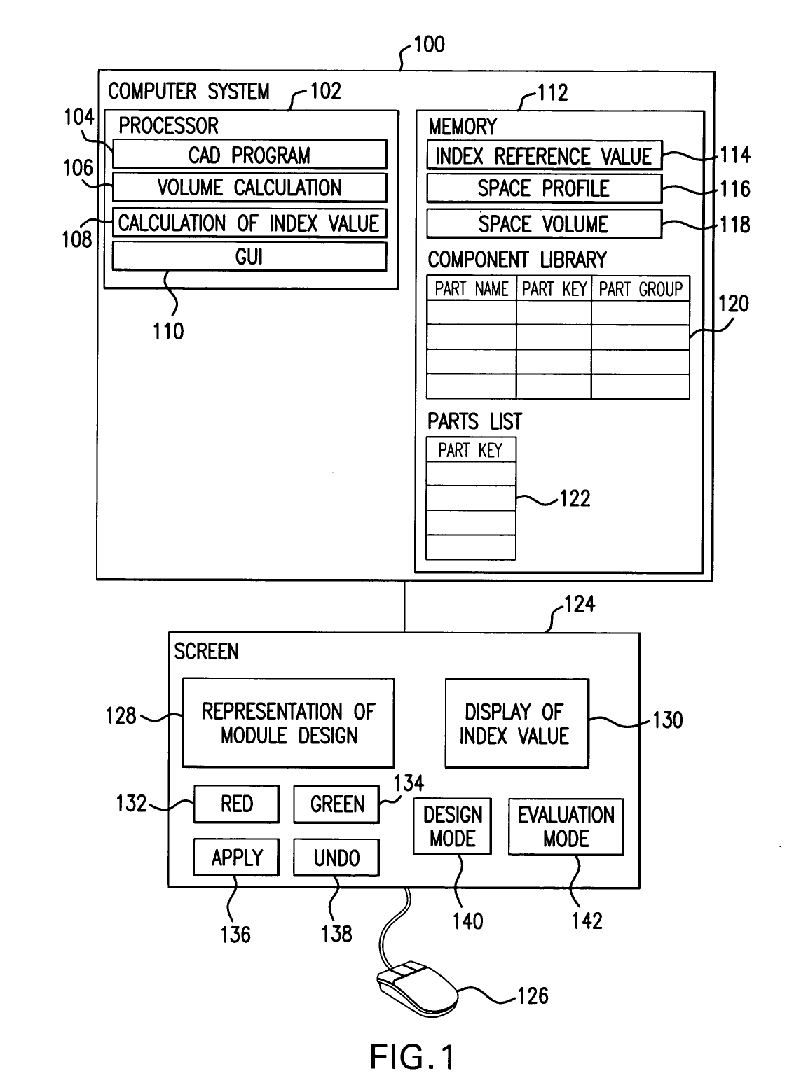

FIG. 1 shows a block diagram of computer system 100. Computer system 100 has at least one processor 102 to run various computer programs. In particular, this involves CAD program 104, program 106 to calculate the volume of components, component groups, or package space profiles specified by CAD data, program 108 to calculate an index value, and program 110, which serves to generate a graphical user interface (GUI).

Computer system 100 has memory 112 with memory area 114 for storing a reference value, memory area 116 for storing data specifying a package space profile, memory area 118 for storing a package space volume calculated from the package space profile, memory area 120 for storing a component library, and memory area 122 for storing a parts list.

The component library contains CAD/CAX data for standardized and parametrizable components. For each of the components, there is an entry in the component library with a part name for the relevant component, a part key for referencing the relevant component, and an indication of the part group to which the component belongs. If computer system 100 is used to design a cockpit module, then three different part groups can be defined, for example, namely air-conditioning components, storage components, and other functional components.

The parts list contains the part keys of those components that have been selected from the component library for the design of the module.

Computer system 100 has screen 124, which is used to display various display windows and virtual controls. A user of computer system 100 can access these using a standard computer mouse 126, for example.

In particular, screen 124 is used to display window 128, which is used to display a representation of the module design entered so far. Window 130 is used to display the index value calculated by program 108, which can be subdivided by part groups or alternatively by module components.

Screen 124 is also used to display red symbol 132 and green symbol 134, as well as virtual controls 136, 138, 140, and 142.

By clicking on control 136 using computer mouse 126, the user can start program 108, thereby obtaining a display of the index value on window 130. Depending on the index value and the operating mode selected through clicking on controls 140 or 142, either red symbol 132 appears or green symbol 134. If, in view of the information displayed on screen 124, the user wishes to undo a previously entered change or addition to the design of the module, this can be achieved by clicking on control 138.

Control 140 is used to select a design mode, which is selected during the design of the module, i.e., as long as the module has not yet been completed. Once the design of the module has been completed, the evaluation mode is selected by clicking on control 142.

Before designing a module, a package space profile, typically specified by an automobile manufacturer, is first saved to memory area 116. With the aid of program 108, a package space volume is calculated from this, which is saved to memory area 118. With the aid of program 104, the component library is used to enter a design for the desired module in a step-by-step process, whereby the part keys of the components selected for this purpose from the component library are saved to memory area 122.

The corresponding design is displayed on window 128. The user can start program 106 by clicking on control 136, so that the volume of the previously entered module is automatically calculated from the CAD data. Program 108 is then started, which accesses memory area 118 and calculates the ratio of the volume of the module and the total available volume of the package space. The corresponding component density index value is displayed on window 130.

In addition, corresponding index values can be calculated for part groups of the module. For this purpose, program 106 performs the calculation of volume separately for all the components of a part group from the part list, as well as the calculation of the part group-specific component density index value. The overall component density index value is then calculated from the sum of the individual sub-indices.

During the design phase, the corresponding operating mode can be selected by clicking on control 140. If the most recently calculated component density index value lies below the reference value stored in memory area 114, then green symbol 134 appears, since, in this case, the design of the module is of high quality. In the opposite case, red symbol 132 appears.

In the evaluation mode, which is selected by clicking on control 142, this behavior is reversed. If the calculated component density index value lies above the reference value, which is stored in memory area 114, then this signifies a high-quality module design, which means that green symbol 134 appears; in the opposing case, red symbol 132 appears. If red symbol 132 appears, then the user can undo a previously entered change to the module design by clicking on control 138.

Thus, the index according to the invention can be defined as follows:

$$\frac{volume\_of \_module}{volume\_of \_package \_space} ;$$

An index value of 0.4, for example, means that 40 percent of the available package space is being used.

This index value can be used for benchmark testing of the cockpit. It represents a value that can be drawn upon for analysis of the integration potential and the arrangement of the component package. In addition to this value, three more volume percentage values are calculated, for example: useful volume percentage, air-conditioning component percentage, and remaining functional component percentage. These can be used for analysis that is more intensive.

The useful volume percentage is beneficial for investigations into which package provides the best benefits for the vehicle occupants. The air-conditioning component percentage can be used to calculate the air-conditioning plausibility check value. The remaining functional components comprise the structural, safety, steering assembly, control, and electronics components.

The first sub-index specifies the useful volume percentage, in particular of the storage volume, of the component group. This includes storage pockets and glove compartments, i.e., any volume that can be used by people inside the vehicle interior. This must then be related to the overall volume of the cockpit package space.
useful volume percentage/overall volume=φₓ

The second sub-index specifies the volume percentage of the air-conditioning components, i.e., the proportion of the overall volume represented by air ducts (with volume) and the air-conditioning unit.
air-conditioning components/overall volume=φ_{y}

The third sub-index specifies the volume percentage of the remaining components of the module. These include primary functional components, structural components, safety components, steering assembly, control, and electronics components. Again, the ratio of these components is set against the overall package space.
functional components/overall volume=φ_{z}

The corresponding division of the components into part groups can be established by the conventions of the participating manufacturer.

The sum of these components gives us the component density:
a. φₚ=φₓ=φ_{y}=φ_{z}

The individual components of this index value are a useful resource for special analyses. As a rule, the individual factors must be taken into consideration in an evaluation of the cockpit. For example, two different cockpits could have the same index value, while also fulfilling the same functions. In this case, the key factor is the useful volume percentage. The cockpit with the higher useful volume percentage is better, since a larger portion of the volume ends up directly benefiting the vehicle occupants.

In an alternative case, the index value of one cockpit could be far higher than that of another. Despite this fact, under certain circumstances, it may not be possible to define which package is better solely based on this value. For example, it could be that the air-conditioning unit constitutes the bulk of the component density. It would then be reasonable to question whether an air-conditioning unit of this size actually makes sense for the type of vehicle under discussion. This is why, in cases such as this, it is useful to calculate a further value that provides a measure of the dimensions taken up by the air-conditioning unit in the vehicle.

Many automobiles from equivalent segments feature air-conditioning units of different sizes. In order to express this size as a general figure, it is expedient to calculate an air-conditioning plausibility check number. The air-conditioning plausibility check is calculated by relating the air-conditioning components to the vehicle interior space. This provides a measure of the dimensions of the air-conditioning components as compared to a competing model.
air-conditioning components/vehicle interior space=φ_{KL}

In order to calculate values that are comparable on a cross-manufacturer basis, some conventions must be adhered to regarding the data that is used to calculate the components.

In order to arrive at an objectively comparable index value, it is also necessary to have a convention stipulating the volume of a component that is to be incorporated in the calculation of the index value. Preferably, the functional space enclosed by a component shall also be considered to form part of the component's volume. For example, this would mean that the air volume enclosed by an air duct would form part of the air duct's volume, as would the storage space of a glove compartment.

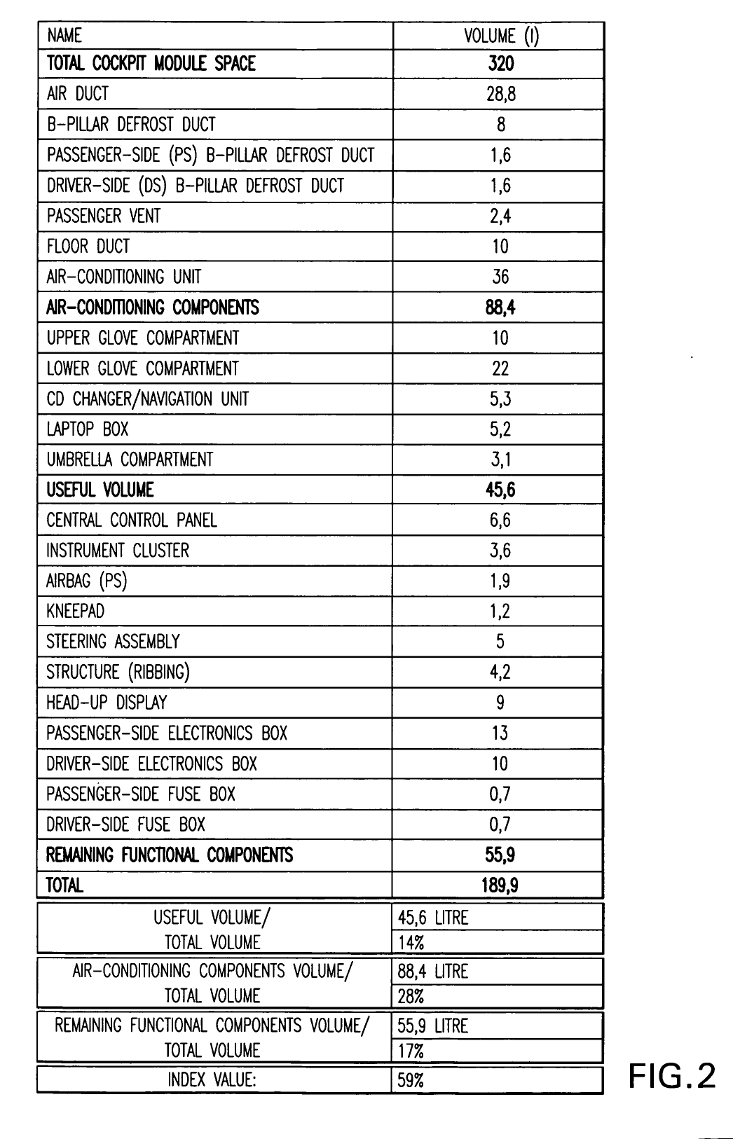

FIG. 2 shows an example of an output on screen window 130 in computer system 100 of FIG. 1. In this connection, a breakdown was selected by the part groups “air-conditioning components”, “useful volume”, and “remaining functional components”. The air-conditioning components include the air duct, the B-pillar defrost duct, the passenger-side (PS) B-pillar defrost duct, the driver-side (DS) B-pillar defrost duct, the passenger vents, the floor ducts, and the air-conditioning unit.

The useful volume includes the upper glove compartment, the lower glove compartment, the CD changer and navigation unit, the laptop box, and the umbrella compartment.

Remaining functional components include a central control panel, an instrument cluster, airbag (PS), kneepad, steering assembly, structure (ribbing), head-up display, passenger-side and driver-side electronics box, and a passenger-side and driver-side fuse box.

The total available package space for the cockpit module comes to 320 liters. In contrast, the overall volume of the cockpit module comes to 189.9 liters, which produces an index value of 59 percent. This is composed of 14 percent for the useful volume, 28 percent for the air-conditioning components, and 17 percent for the remaining functional components.

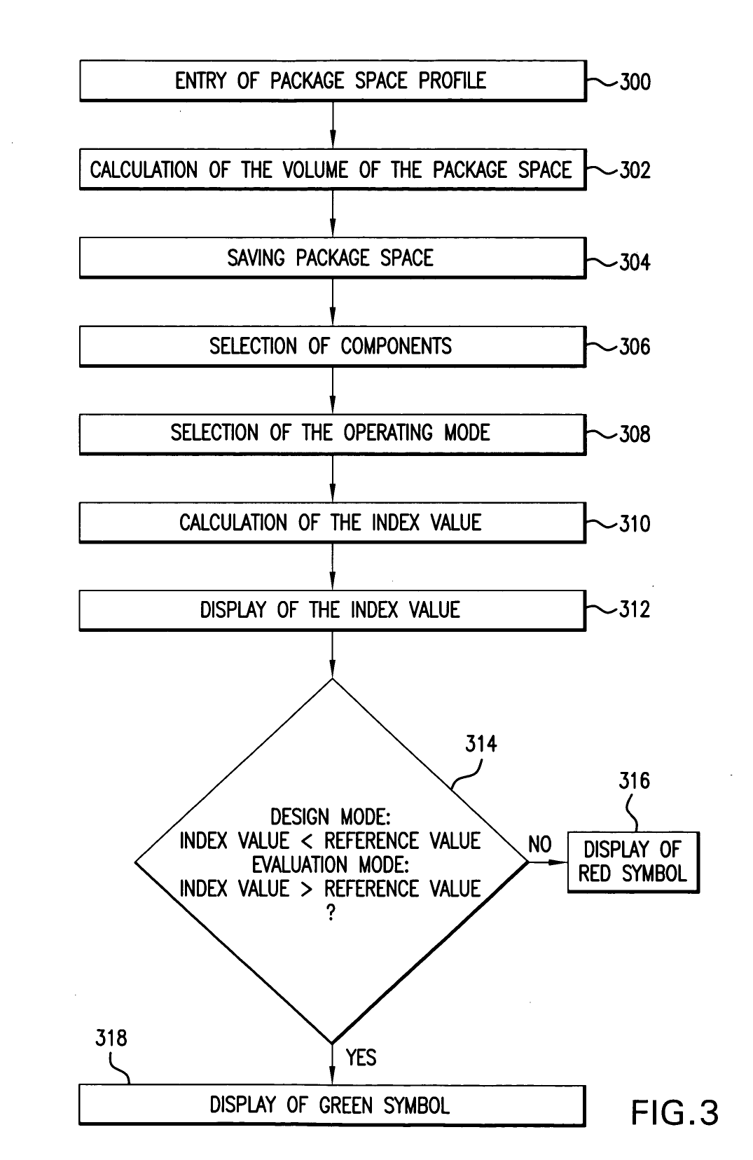

FIG. 3 shows a flow diagram of an embodiment of the method according to the invention. In step 300, a package space profile of the package space provided for the module is entered. The package space profile is usually specified by the automobile manufacturer. In step 302, the volume of the package space is calculated from the package space profile. This is the total available volume to accommodate the module. The volume of the package space is saved in step 304.

In step 306, a design for the module is entered by a user through the selection and parameterization of components from a component library. In step 308, the relevant operating mode is entered, i.e., the development or design mode in the case under consideration here.

Once the design has been partially entered, for example, a calculation of the component density value, i.e., of the index value according to the invention, is initiated in step 310. In addition to the index value, it is also possible to calculate sub-indices, which indicate the contribution of individual part groups to the utilization of the package space volume, as shown in the example of FIG. 2. In step 312, the component density value(s) is/are displayed.

If, in the design mode, the component density value is smaller than a reference value, this shows that the design of the corresponding module is of high quality (step 314), which means that a green symbol is displayed in step 318. Should the opposite be the case then a red symbol will be displayed in step 316.

In the evaluation mode, this behavior is reversed, i.e., a high component density value above the reference value indicates a high-quality design, which means that a green symbol is displayed in step 318; while, in the opposing case, a red symbol is displayed in step 316.

Preferably, the calculation of the volume of the module is conducted in such a way that the individual components are viewed as so-called “solids”, i.e., the functional space enclosed by the components is included in the calculation of their volume.

Various methods can be used to determine the volume of the module. If a CAD system is used, such as computer system 100 of FIG. 1, then the CAD/CAX data, which specifies the design of the module with its various components, can be used to automatically calculate the volume.

In the event that a model or prototype is available of the module being designed, then it is also possible to use other methods to determine the volume. Appropriate photometric or optical methods are available for this purpose. One example is to optically capture the vertices of the module, which are determined by the module's profile. Once these volume vertices have been recorded, the volume can be calculated. Corresponding methods are known that are capable of reading CAD/CAX data from components.

A further possibility for calculating the volume is to immerse the module in a fluid, in particular a liquid, for example water, or an amorphous solid substance such as sand. The functional spaces of the components must be sealed in this process to protect against fluid penetration. The volume of the module can be calculated by determining the volume of the displaced fluid.

### LIST OF REFERENCE NUMBERS

100 computer system
102 processor
104 program
106 program
118 program
110 program
112 memory
114 memory area
116 memory area
118 memory area
120 memory area
122 memory area
124 screen
126 computer mouse
128 window
130 window
132 symbol
134 symbol
136 control
138 control
140 control
142 control

What is claimed is:

1. Computer system comprising:
means of storing a specified package space profile,
CAD program for designing a module to be accommodated in the package space profile,
means of calculating the volume of the package space and the volume of the module,
means of calculating a ratio from the volume of the module and the volume of the package space,
means of displaying the ratio on a screen.

2. Computer system of claim 1, with means of comparing the ratio with reference value, whereby, depending on the result of the comparison, a first or a second signal is emitted for a user.

3. Computer system of claim 1, with means of selecting a first or a second operating mode, wherein the first operating mode is provided for a module design phase and the second operating mode is provided for a module evaluation phase; wherein, in the first operating mode, the first signal is emitted if the ratio is smaller than the reference value, and wherein, in the second operating mode, the first signal is emitted if the ratio is larger than the reference value.

4. Computer system of claim 1 with user interface for entering a user request to calculate the ratio.

5. Computer system of claim 4, wherein the user interface for entering the user request is exercised through a mouse click.

6. Computer system of claim 4, wherein a graphical user interface is featured with first display window for displaying the module, second display window for displaying the ratio, and virtual control for entering the user request.

7. Computer system of claim 6, with additional virtual controls for undoing a previously entered change to the module and for selecting the first or second operating mode.

8. Computer system of claim 1, with means for assigning each component of the module to a part group.

9. Computer system of claim 8, wherein the assignment is conducted in a component library.

10. Computer system of claim 8, wherein, for each of the part groups of the module's components, a part ratio is calculated from the volume of the relevant part group and the volume of the package space.

11. Specification of an index for evaluating the quality of an automobile interior trim part as the ratio of the volume of the automobile interior trim part and the volume of a specified package space.

12. Specification of claim 11, wherein the automobile interior trim part is composed of several components, each of which are assigned to part groups, and the index is composed of corresponding sub-indices for each of the sub-modules.

13. Specification of claim 11, wherein the automobile interior trim part is a cockpit module or a door module.

14. Specification of claim 11, wherein the automobile interior trim part includes the following part groups: storage components, air-conditioning components, and other functional components.

15. Method for calculating an index to evaluate the quality of an automobile interior trim part in accordance with the specification of claim 11, comprising with the following steps:
calculation of the package space volume of a specified package space profile designed to accommodate the automobile interior trim part,
calculation of the volume of the automobile interior trim part,
calculation of a ratio of the volume of the automobile interior trim part and the volume of the package space.

16. Method of claim 15, wherein the volume of the automobile interior trim part is calculated from CAD/CAX data, whereby functional spaces are incorporated in the calculation as solids.

17. Method of claim 15, wherein the volume of the automobile interior trim part is determined with the aid of a photometric or optical method.

18. Method of claim 15, wherein the volume of the automobile interior trim part is determined by calculating the displacement volume of a fluid.

19. Method of claim 18, wherein the fluid is a liquid, in particular water, or an amorphous solid substance, in particular sand.
